(19) United States
(12) Patent Application Publication
(10) Pub. No.: US 2009/0313704 A1
(43) Pub. Date: Dec. 17, 2009

(54) CONTENT MANAGEMENT METHODS AND SYSTEMS

(75) Inventors: Chi-Yang CHOU, Kao-hsiung (TW); Pei-Yen CHOU, Hsin-chu (TW); Yeu-Chung LIN, Chang-hua (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: CONDEL INTERNATIONAL TECHNOLOGIES INC., George Town (KY)

(21) Appl. No.: 12/137,577

(22) Filed: Jun. 12, 2008

(51) Int. Cl. G06F 7/04

(52) U.S. Cl. 726/29

(57) ABSTRACT

Content management methods and systems are provided. First, a UID of a component of a device is read. The UID may be performed with an operation or not. Then, it is determined whether or not the UID matches with a predefined identification attached to the content. When the UID matches with the predefined identification, the content in the device is allowed to be accessed.

### BACKGROUND OF THE INVENTION

1. Field of the Invention

The disclosure relates generally to content management methods and systems, and, more particularly to content management methods and systems based on an identification of at least one component of a device storing content.

2. Description of the Related Art

With electronic devices, such as computers or portable devices, being popular, digital content has become a major data recording type for the devices due to increased convenience of digital content. Moreover, content providers have been devoted to develop related applications for digital content. Since it is easy to copy and broadcast digital content, the authentication management of digital content has become one of the major developmental areas in the content management art.

In a conventional digital content management system, a user must connect to a server set by a vendor via a network such as an internet or a telecommunication network, and transmits a serial code provided with content to the server for authentication. If the serial code is accepted by the server, the server transmits a pass code to the user. The user can decrypt the content using the pass code, and correspondingly access the content. In this manner, the vendor must additionally establish and manage the authentication server, thus increasing operational costs. Additionally, since the serial code and the pass code are transmitted through the network, user privacy such as a phone number, ID, or IP address, and pass codes may be lost or broken by malice hackers, thus reducing the security of content.

In another conventional digital content management system, a key and a serial code are pre-recorded in a hidden area of a medium, such as a VCD, DVD, or SD card. When an end device, such as an MP3/MP4 player, or PDA wants to access content in the medium, it is determined whether or not the serial code is legally authorized. If the serial code is legally authorized, the content is decrypted using the key, and then accessed. In this manner, the management system requires involvement and handshaking of end device manufacturers and the content providers in order to form an industrial communication protocol. Thus, the management system is unpractical as the benefits of the two parties might not be the same. Additionally, although the key and the serial code are recorded in the hidden area of the medium, it can still be easily broken by persons who have the necessary technical skills. Famous example of the failure of such system is the CSS (Content Scramble System) DRM (Digital Rights Management) of DVD.

In yet another conventional digital content management system, when content is downloaded from an internet to a memory of an end device, a device code of the end device is bundled with the download content. When an electronic appliance wants to access the content, it is determined whether or not the device code of the electronic appliance matches the device code bundled with the content. If the device code of the electronic appliance matches the device code bundled with the content, the electronic appliance accesses the content. In this manner, the content is forced to be bundled to a specific device, thus seriously limiting a user's fair use right of owning the content, since a user will not be able to access the content in other devices. Additionally, the system is not suitable for content pre-recorded in content cards, such as portable flash memory devices, since there is no transmission process of content; therefore the bundling of the device code with content will not automatically occur.

### BRIEF SUMMARY OF THE INVENTION

Content management methods and systems are provided.

In an embodiment of a content management method, an UID (Unique Identification) of a component of a device is read. The UID may or may not be further processed. That is the UID may be further performed with an operation or not. Then, it is determined whether or not the UID matches with a predefined identification. When the UID matches with the predefined identification, content in the device is allowed to be accessed. It is noted that, the predefined identification is pre-generated by the UID and perform the aforementioned operation, if any, and then attached for the content.

An embodiment of a content management system comprises a device and a content management module. The device comprises at least one component having an UID, and content. The content management module comprises a predefined identification. The content management module reads the UID of the component of the device, and determines whether or not the UID matches with the predefined identification. When the UID matches with the predefined identification, the content management module allows the content in the device to be accessed. Similarly, the UID may or may not be further processed before it compares to the predefined identification.

In an embodiment of a content management method, content is stored to a device. An UID of at least one component of the device is read, and recorded to a content management module. When the content is requested to be accessed, the content management module manages the content according to the predefined UID.

Content management methods and systems may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a content management system according to the invention;

FIG. 2 is a schematic diagram illustrating another embodiment of a content management system according to the invention;

FIG. 3 is a flowchart of an embodiment of a content management method according to the invention; and

FIG. 4 is a flowchart of another embodiment of a content management method according to the invention.

### DETAILED DESCRIPTION OF THE INVENTION

Content management methods and systems are provided.

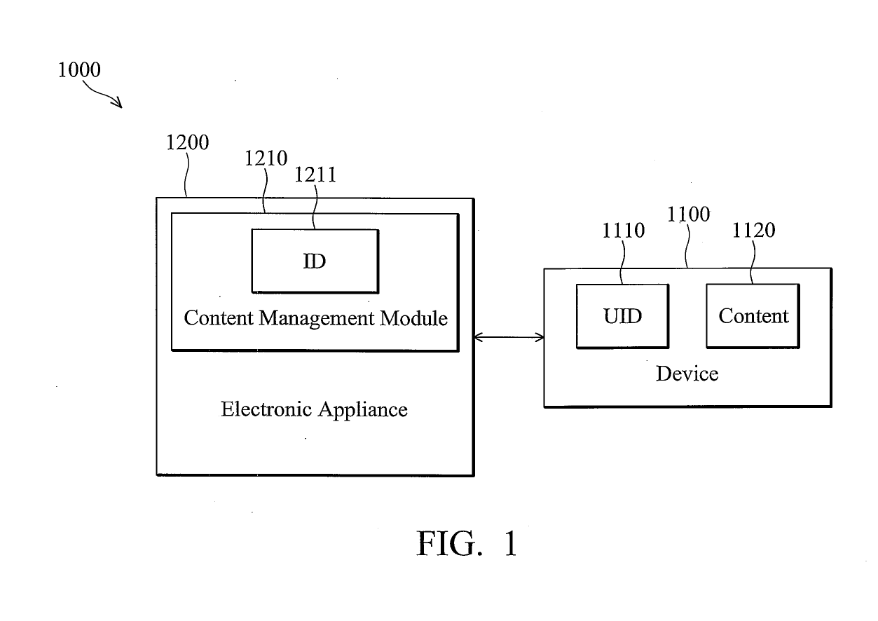

FIG. 1 is a schematic diagram illustrating an embodiment of a content management system according to the invention.

The content management system 1000 comprises a device 1100 and an electronic appliance 1200. The device 1100 may be a memory device, such as a portable flash memory device storing content 1120. In some embodiments, the content 1120 may be encrypted using an encryption/decryption algorithm, such as symmetric or asymmetric encryption/decryption algorithms, and may be digital rights managed. The device 1100 may comprise at least a component (not shown in FIG. 1) having an UID 1110. In some embodiments, the component may be a semiconductor component, such as a memory or a micro-processor of the device 1100. The UID 1110 is a hardware serial number generated for the semiconductor component during manufacturing. The electronic appliance 1200 may be processor-based electronic devices, such as computers, or portable devices such as MP3 players, MP4 players, PDAs, global positioning devices or mobile phones. The electronic appliance 1200 comprises a content management module 1210 including a predefined ID 1211. The content management module 1210 performs the content management methods of the invention according to the predefined ID 1211. Related details are discussed later.

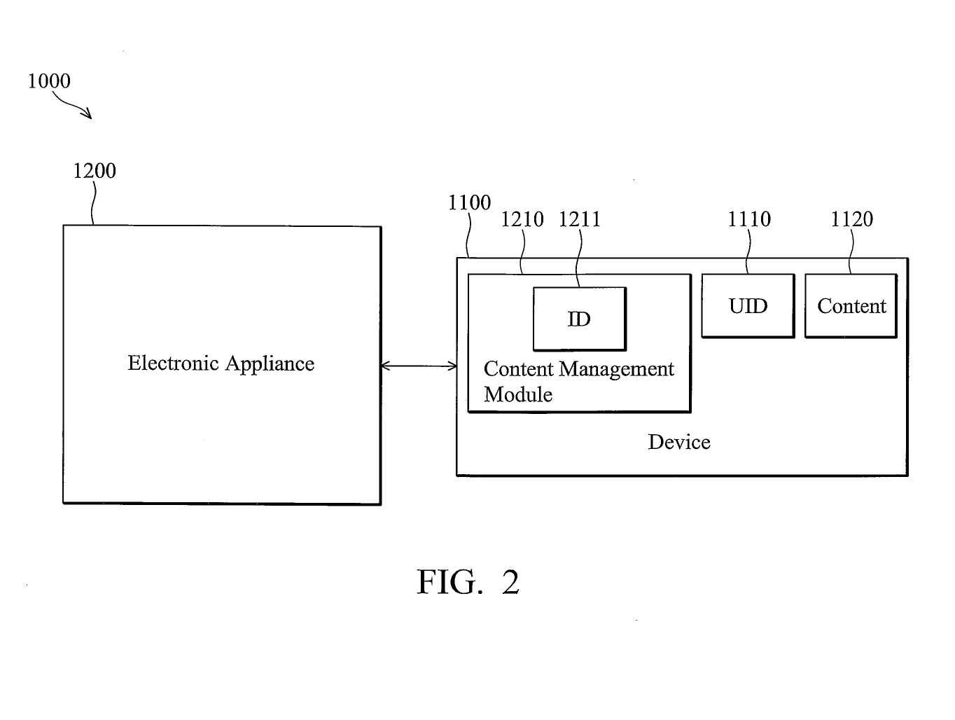

FIG. 2 is a schematic diagram illustrating another embodiment of a content management system according to the invention. It is noted that, the components with the same notations in FIG. 1 and FIG. 2 have the same definitions. In this embodiment, the content management module 1210 is in the device 1100. It is noted that, in this embodiment, the UID 1110 is a hardware serial number generated for the semiconductor component during manufacturing or a virtual serial number created for the semiconductor component by firmware/software. Similarly, the content management module 1210 performs the content management methods of the invention according to the predefined ID 1211, and related details are discussed later.

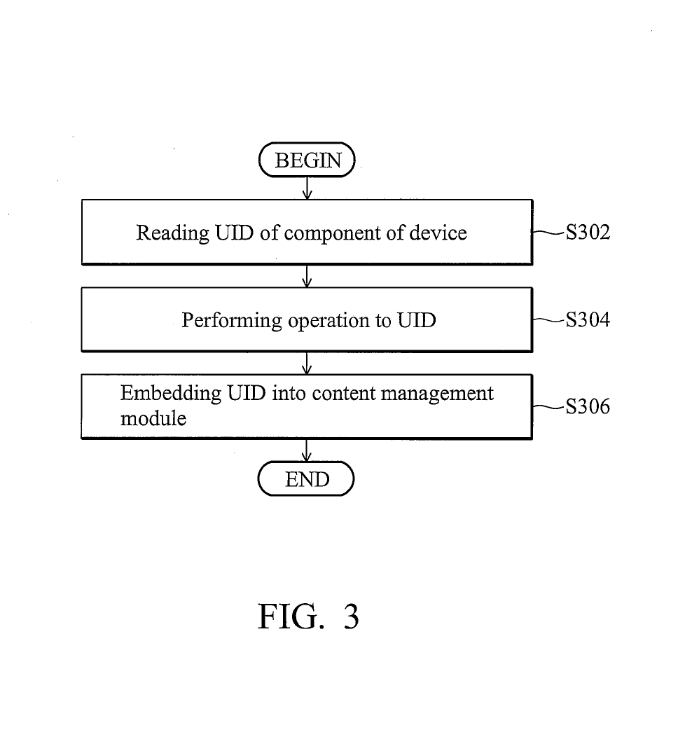

FIG. 3 is a flowchart of an embodiment of a content management method according to the invention. In this embodiment, an UID is embedded into a content management module.

In step S302, an UID of at least one component of a device is read. Similarly, the device may be a memory device storing content, and the component may be a semiconductor component, such as a memory or a micro-processor of the device. The UID may be a hardware serial number generated for the semiconductor component during manufacturing or a virtual serial number created for the semiconductor component by firmware/software. In step S304, the UID is performed with an operation, such as an encryption, a logic operation, or a hash operation. It is understood that, in some embodiments, the UID may not be performed with the operation, that is step S304 can be omitted. In step S306, the UID of the component of the device is embedded into a content management module in an electronic appliance or the device.

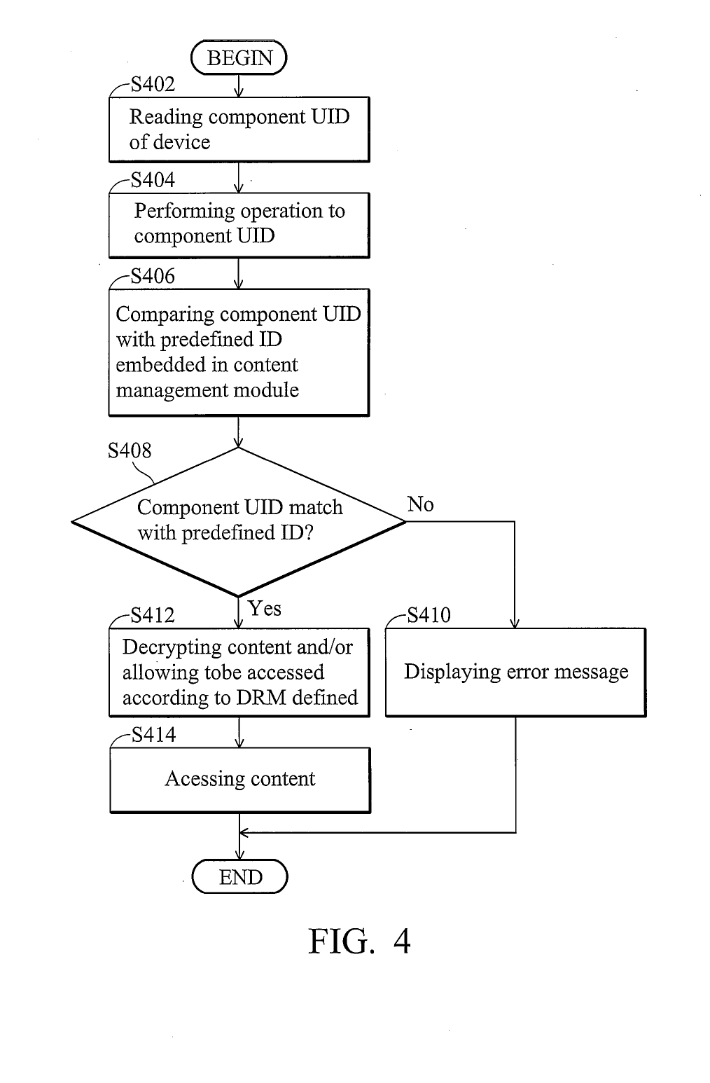

FIG. 4 is a flowchart of another embodiment of a content management method according to the invention.

When content in a device is requested to be accessed, in step S402, a content management module in an electronic appliance or the device reads an UID of at least one component of the device. Similarly, the device may be a memory device storing content, and the component may be a semiconductor component, such as a memory or a micro-processor of the device. The component UID may be a hardware serial number generated for the semiconductor component during manufacturing or a virtual serial number created for the semiconductor component by firmware/software. It is understood that, in some embodiments, when the device is coupled to an electronic appliance, step S402 is performed. In step S404, the component UID of the device is performed with an operation, such as an encryption, a logic operation, or a hash operation. Similarly, in some embodiments, the component UID may not be performed with the operation, that is., step S404 can be omitted. In step S406, the component UID of the device is compared with a predefined ID embedded in the content management module. It is understood that the predefined ID in the content management module is generated according to the embodiment of FIG. 3. When the component UID of the device does not match with the predefined ID embedded in the content management module (No in step S408), in step S410, an error message is displayed. When the component UID of the device matches with the predefined ID embedded in the content management module (Yes in step S408), in step S412, the content is decrypted using an encryption/decryption algorithm, such as symmetric or asymmetric encryption/decryption algorithms and/or allowed to be accessed according to the DRM defined. In step S414, the decrypted content is accessed.

Therefore, the methods and systems of the application can provide novel and inventive manners to manage content based on the component UID of the device storing content, thus reducing the drawbacks in conventional content managements.

Content management methods and systems, or certain aspects or portions thereof, may take the form of a program code (i.e., executable instructions) embodied in tangible media, such as flash card or USB disk, wherein, when the program code is loaded into and executed by a machine, such as a computer, the machine thereby becomes an apparatus for practicing the methods.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A content management method, comprising:
reading a UID of a component of a device;
determining whether or not the UID matches with a predefined identification; and
when the UID matches with the predefined identification, allowing content in the device to be accessed.

2. The method of claim 1, wherein the step of allowing the content in the device to be accessed comprises a step of activating digital rights managed content.

3. The method of claim 1, wherein the step of allowing the content in the device to be accessed comprises a step of accessing the content.

4. The method of claim 1, further comprising performing an operation to the UID of the component before the identification is matched to the predefined identification.

5. The method of claim 4, wherein the operation comprises an encryption, a logic operation, or a hash operation.

6. The method of claim 1, wherein the component comprises a semiconductor component of the device, and the UID is a hardware serial number generated for the semiconductor component during manufacturing or a virtual serial number created for the semiconductor component by firmware/software.

7. The method of claim 6, wherein the semiconductor component comprises a memory or a micro-processor of the device.

8. The method of claim 1, wherein the device comprises a memory device.

9. A content management system, comprising:
a device comprising at least one component having an UID, and content; and
a content management module comprising a predefined identification, reading the UID of the component of the device, determining whether the UID matches with the predefined identification, and when the UID matches with the predefined identification, allowing the content in the device to be accessed.

10. The system of claim 9, wherein the content management module further activates the digital rights managed content.

11. The system of claim 9, wherein the content management module further accesses the content.

12. The system of claim 9, wherein the content management module further performs an operation to the UID on of the component before the UID is matched to the predefined identification.

13. The system of claim 12, wherein the operation comprises an encryption, a logic operation, or a hash operation.

14. The system of claim 9, wherein the component comprises a semiconductor component of the device, and the UID is a hardware serial number generated for the semiconductor component during manufacturing or a virtual serial number created for the semiconductor component by firmware/software.

15. The system of claim 14, wherein the semiconductor component comprises a memory or a micro-processor of the device.

16. The system of claim 9, wherein the device comprises a memory device.

17. A content management method, comprising:
reading a UID of at least one component of the device; and
embedding the UID of the component of the device into a content management module,
wherein when content in the device is requested to be accessed, the content management module manages the content according to the UID.

18. The method of claim 17, further comprising performing an operation to the UID of the component.

19. The method of claim 18, wherein the operation comprises an encryption, a logic operation, or a hash operation.

20. The method of claim 17, wherein the component comprises a semiconductor component of the device, and the UID is a hardware serial number generated for the semiconductor component during manufacturing or a virtual serial number created for the semiconductor component by firmware/software.

21. The method of claim 20, wherein the semiconductor component comprises a memory or a micro-processor of the device.

22. The method of claim 17, wherein the device comprises a memory device.

23. A machine-readable storage medium comprising a program, which, when executed, causes a device to perform a content management method, the method comprising:
reading a UID of a component of a specific device;
determining whether the UID matches with a predefined identification; and
when the UID matches with the predefined identification, allowing content in the specific device to be accessed.
